(19) United States
(12) Patent Application Publication
(10) Pub. No.: US 2021/0242752 A1
(43) Pub. Date: Aug. 5, 2021

(54) MOTOR DEVICE WITH COIL HEAT DISSIPATION STRUCTURE

(71) Applicant: GRENERGY OPTO, INC., Hsinchu City (TW)

(72) Inventors: SHAN-NAN CHEN, Hsinchu City (TW); SHENG-WEN CHEN, Hsinchu City (TW)

(21) Appl. No.: 16/889,405

(22) Filed: Jun. 1, 2020

(30) Foreign Application Priority Data
Feb. 3, 2020 (TW) 109103148

(51) Int. Cl. H02K 9/22; H02K 1/16

(52) U.S. Cl. CPC H02K 9/22; H02K 1/165

(57) ABSTRACT

A motor device with a coil heat dissipation structure is provided. The motor device includes a motor, a plurality of coils, and a plurality of thermal conduction glues. The motor includes a rotor and a stator. The stator is disposed at an outer periphery of the rotor. The stator includes an iron core assembly. The iron core assembly includes a plurality of winding portions. Each of the winding portions is provided with two winding grooves at two sides thereof. The coils wind around and cover the winding grooves of the winding portions. The thermal conduction glues are covered on an outer periphery of the coils, and the thermal conduction glues are filled in a plurality of gaps between the coils and the winding grooves.

### CROSS-REFERENCE TO RELATED PATENT APPLICATION

This application claims the benefit of priority to Taiwan Patent Application No. 109103148, filed on Feb. 3, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a motor device with a coil heat dissipation structure, and more particularly to a motor device with a coil heat dissipation structure for cooling an electrical motor.

### BACKGROUND OF THE DISCLOSURE

Internal combustion engines are power sources of conventional vehicles. However, since the supply of fossil fuel will gradually be depleted in the future and the fossil fuel results in air pollution and carbon dioxide emission, electric vehicles have received an increasing amount of attention and have become more popular in the market.

In the electric vehicles, the internal combustion engines are replaced by motors as the power sources. In the past, the electric vehicles were limited by the battery storage capacity and the motor output power so that the endurance and the power performance of the electric vehicles were worse than the vehicles with the internal combustion engines, and the electric vehicles were not as easily accepted in the market. However, in recent years, with the improvement of battery technologies and motor technologies, the endurance and the power performance of the electric vehicles have exceeded those of the vehicles with the internal combustion engines, so that the electric vehicles have gradually become popular in the market. Since the power of the electric vehicles has increased, the motors in operation generate more heat, so that heat dissipation abilities of the motors needs to be improved.

The heat generated by the motor in operation primarily results from a copper loss, an iron core loss, a wind resistance loss, and a friction loss of a bearing of the motor. The copper loss results from a current flowing through a plurality of coils of a stator of the motor, the iron core loss results from an alternating magnetic flux passing through an iron core of the stator, and the wind resistance loss and the friction loss result from a rotor in rotation. Generally, an insulation sleeve made of plastic materials is disposed between the coils and the iron core of the stator of the conventional motor to separate the coils and the iron core, and to provide insulation therebetween. However, since the plastic materials lacks sufficient thermal conductivity, the heat generated by the coils cannot be easily transferred to the iron core, the heat accumulates at the coils inside of the motor, and results in overheating.

### SUMMARY OF THE DISCLOSURE

In response to the above-referenced technical inadequacies, the present disclosure provides a motor device with a coil heat dissipation structure to improve on a heat dissipation effect of a conventional motor.

In one aspect, the present disclosure provides a motor device with a coil heat dissipation structure including a motor, a plurality of coils, and a plurality of thermal conduction glues. The motor includes a rotor and a stator. The stator is disposed at an outer periphery of the rotor. The stator includes at least one iron core assembly, the at least one iron core assembly includes a plurality of winding portions, and each of the winding portions has two winding grooves respectively disposed at two sides of the corresponding one of the winding portions. The coils wind around and cover the winding grooves of the winding portions. The thermal conduction glues are covered on an outer periphery of the coils, and the thermal conduction glues are filled in a plurality of gaps between the coils and the winding grooves.

In certain embodiments of the present disclosure, each of the winding portions is provided with an insulation sleeve disposed thereon, and the insulation sleeve is disposed between the corresponding one of the coils and the two winding grooves of the corresponding one of the winding portions. Each of the insulation sleeves has two side substrates, the two side substrates are respectively abutted against two groove bottom surfaces of the two winding grooves, each of the side substrates partially covers the corresponding one of the groove bottom surfaces to form at least one hollow portion, and the thermal conduction glues are in contact with the groove bottom surfaces through the at least one hollow portion.

In certain embodiments of the present disclosure, each of the insulation sleeves surrounds the corresponding one of the winding portions, and each of the side substrates is provided with at least one thru-hole to form the at least one hollow portion.

In certain embodiments of the present disclosure, each of the winding portions is provided with two of the insulation sleeves disposed thereon, and the two insulation sleeves are disposed opposite to each other and are disposed at two ends of the corresponding one of the winding portions along a longitudinal direction of the at least one iron core assembly. The two insulation sleeves respectively include two side substrates, two ends of the two side substrates of the two insulation sleeves at the two ends of the corresponding one of the winding portions are opposite to each other, and a hollow portion is formed between the two ends of the two side substrates of the two insulation sleeves so that the groove bottom surfaces at the hollow portion are not covered by any one of the two side substrates.

In certain embodiments of the present disclosure, the at least one iron core assembly includes a plurality of iron core blocks, and each of the iron core blocks has one of the winding portions at one side thereof facing toward the rotor.

Therefore, the motor device with the coil dissipation structure of the present disclosure includes the effects as follows. Through the thermal conduction glues, heat of the coils can be transferred to the at least one iron core assembly, and the heat can be further transferred to a shell of the motor or a heat dissipation device through the at least one iron core assembly. Therefore, the motor can be quickly cooled, and a heat accumulation inside of the motor can be prevented.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a perspective exploded view of a motor device with a coil heat dissipation structure of the present disclosure according to a first embodiment of the present disclosure.

FIG. 2 is an assembled sectional view of the motor device with the coil heat dissipation structure of the present disclosure according to the first embodiment of the present disclosure.

FIG. 3 is a perspective assembled view of a stator of the motor device with the coil heat dissipation structure of the present disclosure according to the first embodiment of the present disclosure.

FIG. 4 is an assembled sectional view of the stator of the motor device with the coil heat dissipation structure of the present disclosure according to the first embodiment of the present disclosure.

FIG. 5 is a perspective assembled view of an iron core block of the stator of the motor device with the coil heat dissipation structure of the present disclosure according to the first embodiment of the present disclosure.

FIG. 6 is a perspective exploded view of the iron core block, an insulation sleeve, and a coil of the motor device with the coil heat dissipation structure of the present disclosure according to the first embodiment of the present disclosure.

FIG. 7 is an assembled sectional view of the iron core block of the stator of the motor device with the coil heat dissipation structure of the present disclosure according to the first embodiment of the present disclosure.

FIG. 8 is an assembled sectional view along line XIII-XIII in FIG. 7 of the iron core block of the stator of the motor device with the coil heat dissipation structure of the present disclosure according to the first embodiment of the present disclosure.

FIG. 9 is a perspective exploded view of the iron core block and the insulation sleeve of the motor device with the coil heat dissipation structure of the present disclosure according to a second embodiment of the present disclosure.

FIG. 10 is a perspective assembled view of the iron core block and the insulation sleeve of the motor device with the coil heat dissipation structure of the present disclosure according to the second embodiment of the present disclosure.

FIG. 11 is an assembled sectional view of the iron core block of the motor device with the coil heat dissipation structure of the present disclosure according to the second embodiment of the present disclosure.

FIG. 12 is a perspective exploded view of the iron core block and a thermal conduction member of the motor device with the coil heat dissipation structure of the present disclosure according to a third embodiment of the present disclosure.

FIG. 13 is a perspective assembled view of the iron core block and the thermal conduction member of the motor device with the coil heat dissipation structure of the present disclosure according to the third embodiment of the present disclosure.

FIG. 14 is an assembled sectional view of the motor device with the coil heat dissipation structure of the present disclosure according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

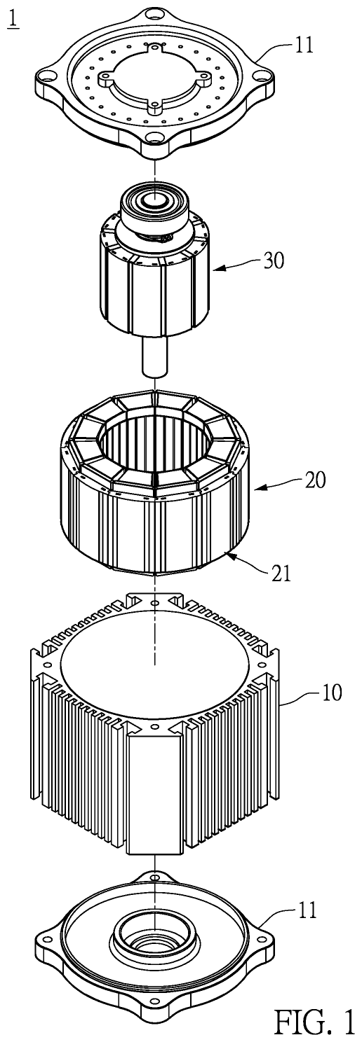

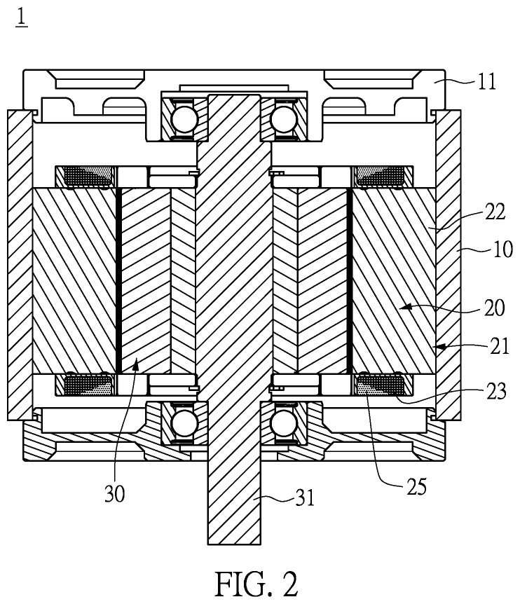

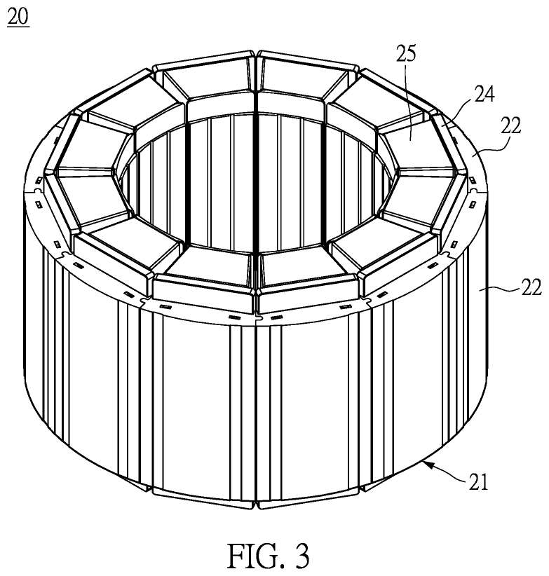

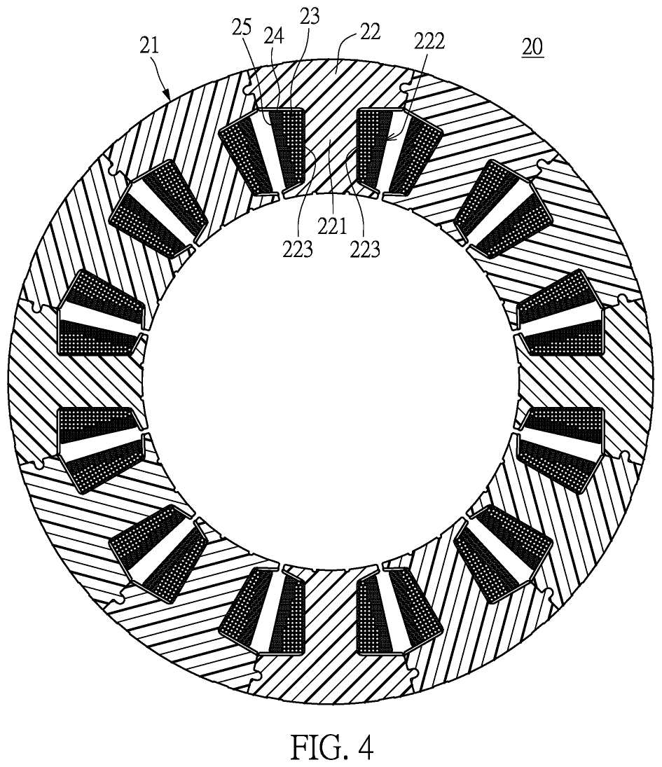

Referring to FIG. 1 to FIG. 4, the present disclosure provides a motor device with a coil dissipation structure, and the motor device includes a motor 1. The motor 1 includes a shell 10, a stator 20, and a rotor 30, the latter two of which are disposed inside of the shell 10. The stator 20 includes an iron core assembly 21. The iron core assembly 21 is substantially in a ring shape. The rotor 30 penetrates through a center of the iron core assembly 21. As shown in FIG. 3, in the present embodiment, the iron core assembly 21 of the stator 20 is formed by assembling a plurality of iron core blocks 22. In each of the iron core blocks 22, a winding portion 221 is formed at one side of the iron core block facing toward the rotor 30, two winding grooves 222 are respectively disposed at two sides of the winding portion 221, and a coil 23 winds surroundingly around the two winding grooves 222 of the winding portion 221 to form a plurality of armatures. The rotor 30 is disposed at a center of the stator 20 and includes a shaft 31. The shaft 31 penetrates and protrudes from an end plate 11 of the shell 10. When each of the coils 23 of the stator 20 is provided with electricity, each of the coils 23 and the rotor 30 generate a rotating magnetic field to drive the rotor 30 to rotate.

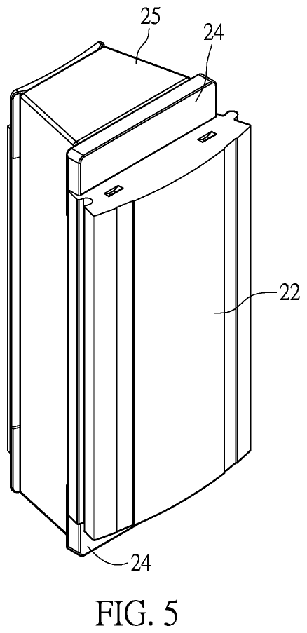

Referring to FIG. 3 to FIG. 8, an outer periphery of the coil 23 of each of the iron cores 22 is covered by a thermal conduction glue 25, and the thermal conduction glue 25 penetrates through a plurality of gaps of the coil 23 to a gap between the coil 23 and the winding grooves 222 of the iron core block 22. Since the coil 23 is in contact with the iron core block 22 through the thermal conduction glue 25, heat of the coil 23 can be transferred to the iron core block 22 through the thermal conduction glue 25. Therefore, a heat dissipation efficiency of the stator 20 can be increased, and the motor 1 in operation can be prevented from internally accumulating heat.

It should be noted that the iron core assembly 21 in the present embodiment is an assembled structure detachably formed by the iron core blocks 22, but the present disclosure is not limited thereto. In other embodiments, the iron core assembly 21 can be an integral structure formed by a whole silicon steel sheet.

Referring to FIG. 3, a plurality of thermal conduction glues 25 or a thermal paste having a high thermal conductivity can be filled between an outer surface of the iron core assembly 21 and the shell 10 of the motor 1 so that heat can be transferred to the shell 10. Therefore, a heat dissipation path is provided so that the heat of the coil 23 can be transferred to the iron core assembly 21 through the thermal conduction glues 25, and then transferred to the shell 10 through the iron core assembly 21.

In each of the winding portions 221, the two winding grooves 222 are provided with an insulation sleeve 24 disposed thereon. The insulation sleeve 24 is made of insulating plastic materials, and the coil 23 surrounds an outer periphery of the insulation sleeve 24 so that the insulation sleeve 24 is between the coil 23 and the two winding grooves 222. The insulation sleeve 24 can be a spacer and an insulator between the coil 23 and the two winding grooves 222 so that the coil 23 is not directly in contact with the iron core assembly 21, and the coil 23 and the iron core assembly 21 are insulated from each other.

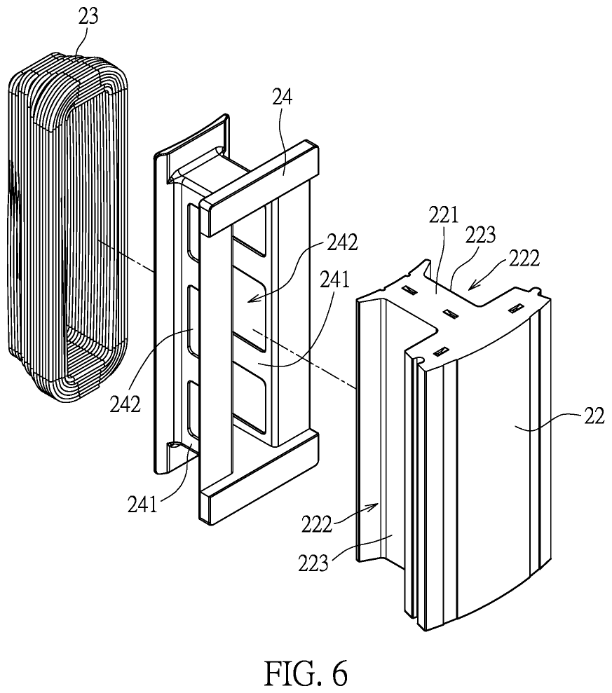

Referring to FIG. 6 to FIG. 8, in each of the iron core blocks 22 of the present embodiment, the insulation sleeve 24 surrounds an outer periphery of the winding portion 221, and the insulation sleeve 24 has two side substrates 241. When the insulation sleeve 24 is disposed at the winding portion 221 of the iron core block 22, the two side substrates 241 are abutted against two groove bottom surfaces 223 of the two winding grooves 222. In the present embodiment, a plurality of hollow portions 242 are formed on the two side substrates 241. Therefore, the two groove bottom surfaces 223 of the two winding grooves 222 are not covered by the insulation sleeve 24 at positions corresponding to the hollow portions 242.

It should be noted that in the present embodiment, the insulation sleeve 24 is made of insulating plastic materials and can be integrally formed in an over-molding manner to be disposed at the outer periphery of the winding portion 221. However, in other embodiments, the insulation sleeve 24 can be an assembly having a plurality of members. For example, the insulation sleeve 24 can be divided into at least two detachable members, and the at least two detachable members can be engaged with the winding portion 221.

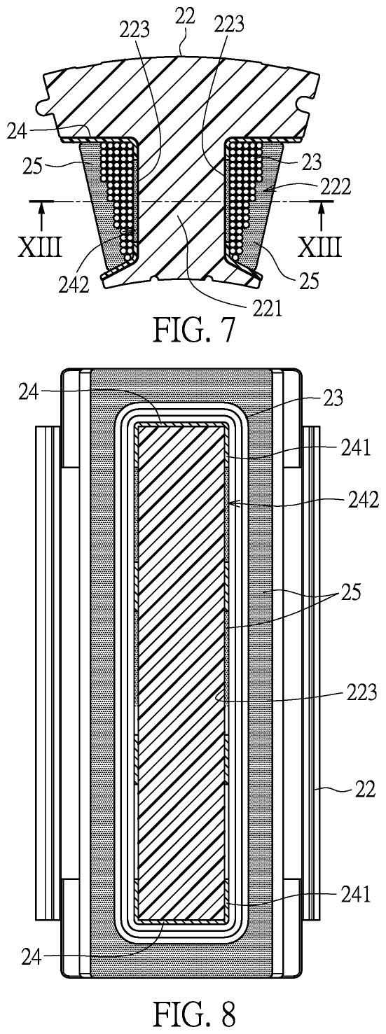

Referring to FIG. 7 and FIG. 8, an assembling method of each of the iron core blocks 22 of the present disclosure is described as below. After the insulation sleeve 24 is disposed on the winding portion 221, the coil 23 is disposed to surround the outer periphery of the two winding grooves 222 and the insulation sleeve 24. Therefore, after the coil 23 is disposed to surround the outer periphery of the winding portion 222 and the insulation sleeve 24, the insulation sleeve 24 is sandwiched between the coil 23 and the two winding grooves 222. An inner surface of the coil 23 and the groove bottom surfaces 223 are spaced apart by the insulation sleeve 24 with a distance. Since the insulation sleeve 24 is provided with the hollow portions 242, the thermal conduction glues 25 at positions corresponding to the hollow portions 242 can be in contact with the groove bottom surfaces 223 of the two winding grooves 222 through the hollow portions 242. Therefore, the thermal conduction glues 25 can be filled in a gap between the coil 23 and the two winding portions 222.

In the present disclosure, the thermal conduction glues 25 can be disposed by a method described below. After the coil 23 is disposed to surround the outer periphery of the winding portion 222 and the insulation sleeve 24, the thermal conduction glues 25 cover the outer periphery of the coil 23 in an over-molding manner through a molding process. When the thermal conduction glues 25 undergo an injection molding process, air in a mold is suctioned away so that the mold is in a vacuum state, and bubbles of the thermal conduction glues 25 disappear. Afterwards, the thermal conduction glues 25 enter the coil 23 through gaps between the coil 23 and are in contact with the groove bottom surfaces 223 of the two winding grooves 222 through the hollow portions 242. Therefore, after the injection molding process is finished, the thermal conduction glues 25 cover the outer periphery of the coil 23 and the gaps of the coil 23, and the gap between the coil 23 and the two winding grooves 222 is filled with the thermal conduction glues 25. Compared with conventional plastics, the thermal conduction glues 25 have a better thermal conductivity, so that the heat of the coil 23 can be quickly transferred from the thermal conduction glues 25 to the iron core assembly 21.

In addition, in the present disclosure, after the insulation sleeve 24 is disposed on the winding portion 221, a first thermal conduction glue disposing step, a winding step, and a second thermal conduction glue disposing step can be implemented in sequence. The first thermal conduction glue disposing step is implemented by disposing a part of the thermal conduction glues 25 on the groove bottom surfaces 223 of the winding grooves 222 and filling up the hollow portions 242 of the insulation sleeves 24 with the thermal conduction glues 25. The winding step is implemented by disposing the coil 23 to surround the outer periphery of the winding grooves 222 and the insulation sleeve 24. The second thermal conduction glue disposing step is implemented by covering the outer periphery of the coil 23 with the thermal conduction glues 25 in a molding manner.

### Second Embodiment

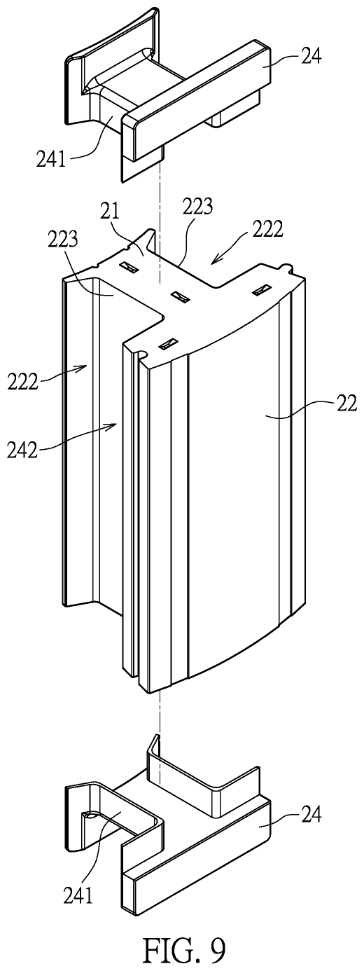

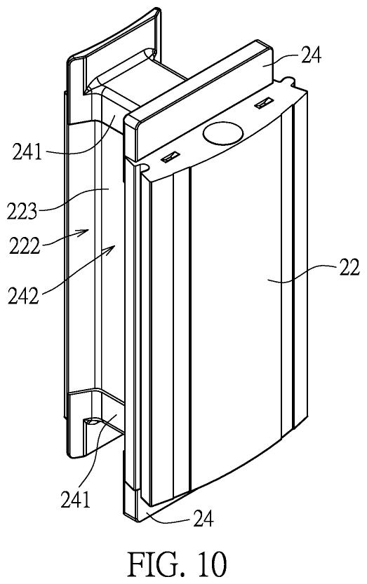

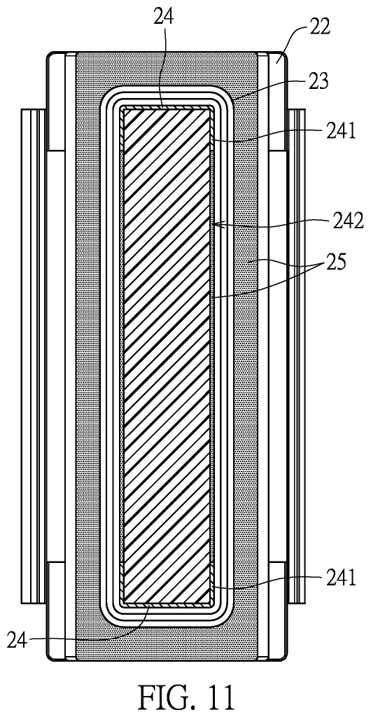

Referring to FIG. 9 to FIG. 11 for the second embodiment of the present disclosure, a basic structure and technical characteristics of the second embodiment that are similar to that of the first embodiment will not be reiterated herein. The difference between the second embodiment and the first embodiment of the present disclosure is that in each of the iron core blocks 22, an insulation structure between the coil 23 and the winding portion 221 is changed into two insulation sleeves 24 respectively disposed at two ends of the winding portion 221 along a longitudinal direction of the iron core block 22. The two insulation sleeves 24 respectively have two side substrates 241. The two insulation sleeves 24 are correspondingly disposed at two ends of the winding portion 221. Two ends of the side substrates 241 of the two insulation sleeves 24 are opposite to each other, and the two side substrates 241 of the two insulation sleeves 24 only partially cover two end portions of the two groove bottom surfaces 223 so that the hollow portions 242 are formed between the two ends of the two side substrates 241 of the two insulation sleeves 24. Therefore, the two groove bottom surfaces 223 between the two ends of the two the side substrates 241 of the two insulation sleeves 24 are exposed from the hollow portions 242.

Referring to FIG. 11, the thermal conduction glues 25 of each of the iron core blocks 22 can be in contact with the two groove bottom surfaces 223 of the two winding grooves 222 through the hollow portions 242 between the two insulation sleeves 24, so that the thermal conduction glues 25 can be filled in the gap between the coil 23 and the winding grooves 222.

The present embodiment shows that the structure of the insulation sleeve 24 can be changed according to practical requirements, but the present disclosure is not limited thereto.

### Third Embodiment

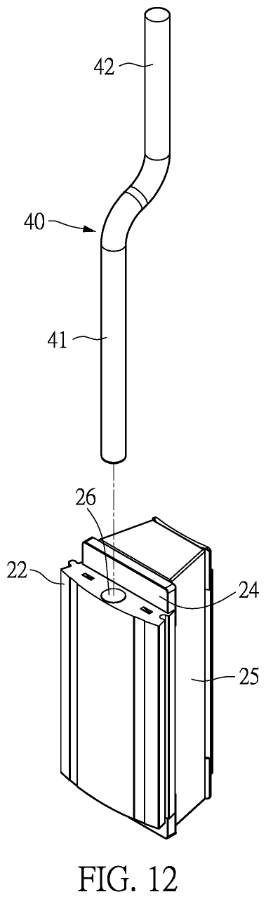

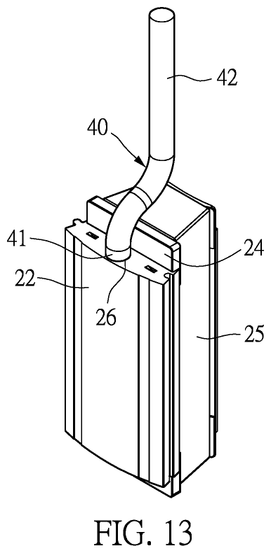

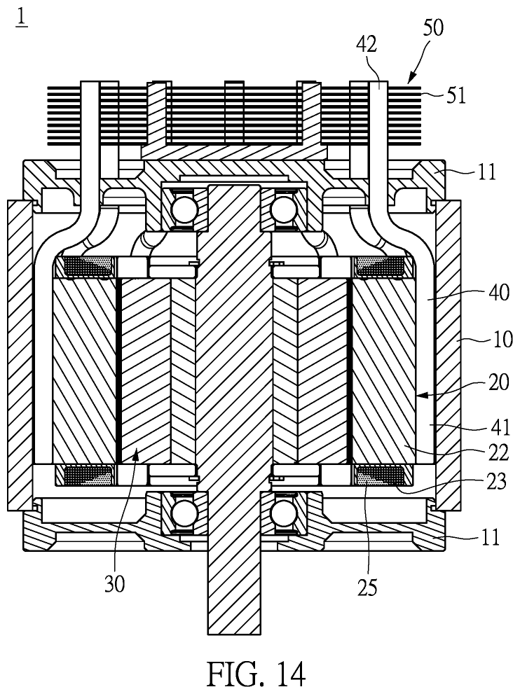

Referring to FIG. 12 to FIG. 14 for the third embodiment of the present disclosure, in the third embodiment, a plurality of thermal conduction members 40 and a heat dissipation device 50 are provided. The thermal conduction members 40 can be heat pipes, or rods or cylinders made of copper. Each of the iron core blocks 22 has a connection groove 26. The connection grooves 26 are configured to be connected to the thermal conduction members 40. Each of the thermal conduction members 40 has a heat absorbing end 41 and a cooling end 42. In each of the iron core blocks 22, the heat absorbing end 41 of the thermal conduction member 40 is inserted into the connection groove 26, and the cooling end 42 of the thermal conduction member 40 penetrates through the end plate 11 of the motor 1 from an inner portion of the shell 10 and extends out of the end plate 11. The heat dissipation device 50 is disposed outside of the end plate 11, and the cooling end 42 of the thermal conduction member 40 is connected to the heat dissipation device 50.

More specifically, a working principle of the heat pipes is described below. When each of the thermal conduction members 40 is a heat pipe, a working fluid in the thermal conduction member 40 evaporates into a gas phase after the heat absorbing end 41 absorbs heat, and the working fluid in the gas phase is transferred to the cooling end 42 through a central space in the thermal conduction member 40 so that heat can be carried to the cooling end 42 by the working fluid that is evaporated into the gas phase. Afterwards, the working fluid is condensed into a liquid phase at the cooling end 42, and the working fluid is transferred back to the heat absorbing end 41 by capillary action. Through a circulation of the working fluid, the heat is continuously transferred from the heat absorbing end 41 having a high temperature to the cooling end 42 having a low temperature 42. Through the thermal conduction members 40, heat of the stator 20 can be quickly transferred to the heat dissipation device 50 so that heat inside of the motor 1 can be directly transferred to the heat dissipation device 50 outside of the shell 10 of the motor 1. Therefore, heat dissipation effects of the coil 23 can be further improved.

It is worth mentioning that in the present embodiment, the configuration of the thermal conduction members 40, the iron core assembly 21, and the heat dissipation device 50 can be changed according to practical requirements. For example, the cooling ends 42 of the thermal conduction members 40 can be connected to a heat dissipation block or a metal plate (not shown) and be connected to the heat dissipation device 50 through the heat dissipation block or the metal plate. Or, the heat absorbing ends 41 of the thermal conduction members 40 can be connected to the iron core assembly 21 through a thermal conduction component (e.g., a metal rack) so that heat of the iron core assembly 21 can be indirectly transferred to the thermal conduction members 40 through the thermal conduction component.

In conclusion, the effects of embodiments of the present disclosure are described below. The heat of the coil 23 of each of the iron core blocks 22 can be quickly transferred to the iron core assembly 21 of the stator 20 through the thermal conduction glues 25, and can be transferred to the shell 10 of the motor 1 or other heat dissipation device through the iron core assembly 21 to cool down the coil 23. Therefore, a heat dissipation effect of the coil 23 of the motor 1 can be improved, and a heat accumulation inside of the motor 1 can be prevented.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A motor device with a coil heat dissipation structure, comprising:
a motor including a rotor and a stator, wherein the stator is disposed at an outer periphery of the rotor, and wherein the stator includes at least one iron core assembly, the at least one iron core assembly includes a plurality of winding portions, and each of the winding portions has two winding grooves respectively disposed at two sides of the corresponding one of the winding portions;
a plurality of coils winding around and covering the winding grooves of the winding portions; and
a plurality of thermal conduction glues covered on an outer periphery of the coils, wherein the thermal conduction glues are filled in a plurality of gaps between the coils and the winding grooves.

2. The motor device according to claim 1, wherein each of the winding portions is provided with an insulation sleeve disposed thereon, and the insulation sleeve is disposed between the corresponding one of the coils and the two winding grooves of the corresponding one of the winding portions, wherein each of the insulation sleeves has two side substrates, the two side substrates are respectively abutted against two groove bottom surfaces of the two winding grooves, each of the side substrates partially covers the corresponding one of the groove bottom surfaces to form at least one hollow portion, and the thermal conduction glues are in contact with the groove bottom surfaces through the at least one hollow portion.

3. The motor device according to claim 2, wherein each of the insulation sleeves surrounds the corresponding one of the winding portions, and each of the side substrates is provided with at least one thru-hole to form the at least one hollow portion.

4. The motor device according to claim 1, wherein each of the winding portions is provided with two of the insulation sleeves disposed thereon, the two insulation sleeves are disposed opposite to each other and are disposed at two ends of the corresponding one of the winding portions along a longitudinal direction of the at least one iron core assembly, the two insulation sleeves respectively include two side substrates, two ends of the two side substrates of the two insulation sleeves at the two ends of the corresponding one of the winding portions are opposite to each other, and a hollow portion is formed between the two ends of the two side substrates of the two insulation sleeves so that the groove bottom surfaces at the hollow portion are not covered by any one of the two side substrates.

5. The motor device according to claim 2, wherein the at least one iron core assembly includes a plurality of iron core blocks, and each of the iron core blocks has one of the winding portions at one side thereof facing toward the rotor.

6. The motor device according to claim 5, wherein each of the insulation sleeves surrounds the corresponding one of the winding portions, and each of the side substrates is provided with at least one thru-hole to form the at least one hollow portion.

7. The motor device according to claim 5, wherein each of the winding portions is provided with two of the insulation sleeves disposed thereon, the two insulation sleeves are disposed opposite to each other and are disposed at two ends of the corresponding one of the winding portions along a longitudinal direction of the at least one iron core assembly, the two insulation sleeves respectively include two side substrates, two ends of the two side substrates of the two insulation sleeves at the two ends of the corresponding one of the winding portions are opposite to each other, and a hollow portion is formed between the two ends of the two side substrates of the two insulation sleeves so that the groove bottom surfaces at the hollow portion are not covered by any one of the two side substrates.

8. The motor device according to claim 5, further comprising a plurality of thermal conduction members, each of the thermal conduction members has a heat absorbing end and a cooling end, the heat absorbing end is connected to the iron core blocks, and the cooling end penetrates and protrudes from a shell of the motor and is connected to a heat dissipation device.

9. The motor device according to claim 8, wherein each of the iron core blocks is provided with a connection groove disposed thereon, and the heat absorbing end of each of the thermal conduction members is connected to the corresponding one of the connection grooves.

10. The motor device according to claim 9, wherein the thermal conduction glues cover an outer periphery of the coils and the winding portions in a molding manner.

11. The motor device according to claim 10, wherein each of the stators undergoes a first thermal conduction glue disposing step, a winding step, and a second thermal conduction glue disposing step, wherein the first thermal conduction glue disposing step is implemented by disposing a part of the thermal conduction glues on the groove bottom surfaces of the winding grooves and filling up the at least one hollow portion with the thermal conduction glues, wherein the winding step is implemented by disposing the coil at an outer periphery of the winding grooves and the insulation sleeves, and wherein the second thermal conduction glue disposing step is implemented by covering the outer periphery of the coil with the thermal conduction glues in a molding manner.

12. The motor device according to claim 10, wherein the thermal conduction glues or a thermal paste is filled between an outer surface of the at least one iron core assembly and the shell of the motor.
